(19) United States
(12) Patent Application Publication
(10) Pub. No.: US 2013/0201086 A1
(43) Pub. Date: Aug. 8, 2013

(54) ACTIVE LIGHT EMITTING DEVICE

(71) Applicants: Bo-Jhang Sun, Kaohsiung City (TW); Chin-Hai Huang, Taoyuan County (TW); Kuan-Yu Chen, Taoyuan County (TW); Szu-Chi Huang, Changhua County (TW)

(72) Inventors: Bo-Jhang Sun, Kaohsiung City (TW); Chin-Hai Huang, Taoyuan County (TW); Kuan-Yu Chen, Taoyuan County (TW); Szu-Chi Huang, Changhua County (TW)

(73) Assignee: CHUNGHWA PICTURE TUBES, LTD., Taoyuan (TW)

(21) Appl. No.: 13/427,900

(22) Filed: Mar. 23, 2012

(30) Foreign Application Priority Data
Feb. 2, 2012 (TW) 101103398

(51) Int. Cl. G09G 3/32

(52) U.S. Cl. 345/76

(57) ABSTRACT

An active light emitting device disposed on a substrate is provided. The active light emitting device includes a scan line, a data line, a power line, a circuit unit, and a light emitting unit. The circuit unit is connected to the scan line, the data line, and the power line. The circuit unit at least includes an overlapping component which is at least partially overlapped with the power line. The light emitting unit is driven by the circuit unit. A light emitting region and a circuit region on the substrate are defined respectively by the light emitting unit and the circuit unit.

### CROSS-REFERENCE TO RELATED APPLICATION

This application claims the priority benefit of Taiwan application serial no. 101103398, filed on Feb. 2, 2012. The entirety of the above-mentioned patent application is hereby incorporated by reference herein and made a part of this specification.

### BACKGROUND OF THE INVENTION

1. Field of the Invention

The invention is related to a light emitting device and more particularly to an active light emitting device.

2. Description of Related Art

With the rapid improvement in information technologies, various types of information processing devices such as personal computers, mobile phones, personal digital assistants (PDA) and digital cameras have been continuously developed. Displays always play an important role in the information devices, and flat panel displays have gradually become popular for their features of thinness, lightweight, and power saving.

Active matrix organic light emitting diode (AMOLED) display is a particular type of flat panel display that has many advantages including a wide viewing angle, a good color contrast, a rapid response, and a low production cost. At present, many devices requiring a small display such as electronic clocks, mobile phones, PDAs and digital cameras uses AMOLED displays.

Nevertheless, the driving circuit of AMOLED is achieved at least by a plurality of transistors and at least one capacitor. The light emitting area of AMOLED is usually restricted by the layout of the driving circuit and fails to be enhanced.

### SUMMARY OF THE INVENTION

The invention provides an active light emitting device having an increased light emitting area.

The invention provides an active light emitting device disposed on a substrate. The active light emitting device includes a scan line, a data line, a power line, a circuit unit, and a light emitting unit. The circuit unit is connected to the scan line, the data line, and the power line while the circuit unit at least includes an overlapping component. The overlapping component is at least overlapped with the power line. The light emitting unit is driven by the circuit unit, wherein the light emitting unit and the circuit unit respectively define a light emitting region and a circuit region on the substrate.

According to an embodiment of the invention, the light emitting unit includes a first electrode, a light emitting layer, and a second electrode stacked sequentially and the first electrode is connected to the circuit unit. The first electrode is, for example, a transparent electrode. The light emitting layer can be an organic light emitting layer.

According to an embodiment of the invention, the circuit unit further includes a first transistor and a second transistor. The overlapping component and the power line together form a storage capacitor. The first transistor is connected to the scan line, the data line, and the overlapping component, and the second transistor is connected to the overlapping component, the power line, and the light emitting unit.

According to an embodiment of the invention, the overlapping component is disposed and located between the substrate and the power line.

In view of the above, the circuit unit of the active light emitting device according to the invention is configured partially overlapped with the power line so that the required area disposing the circuit unit is reduced. Therefore, under the same layout area as a conventional design, the active light emitting device according to the embodiments of the invention can have increased light emitting area, which facilitates the improvement of the light emitting brightness thereof.

In order to make the aforementioned and other features and advantages of the invention more comprehensible, embodiments accompanying figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a schematic view illustrating an active light emitting device array according to a first embodiment of the invention.

FIG. 2 is a schematic view illustrating an active light emitting device according to an embodiment of the invention.

FIG. 3 is a schematic cross-sectional view of the active light emitting device taken along line I-I′ in FIG. 2.

FIG. 4 is a schematic view illustrating an active light emitting device according to another embodiment of the invention.

### DESCRIPTION OF EMBODIMENTS

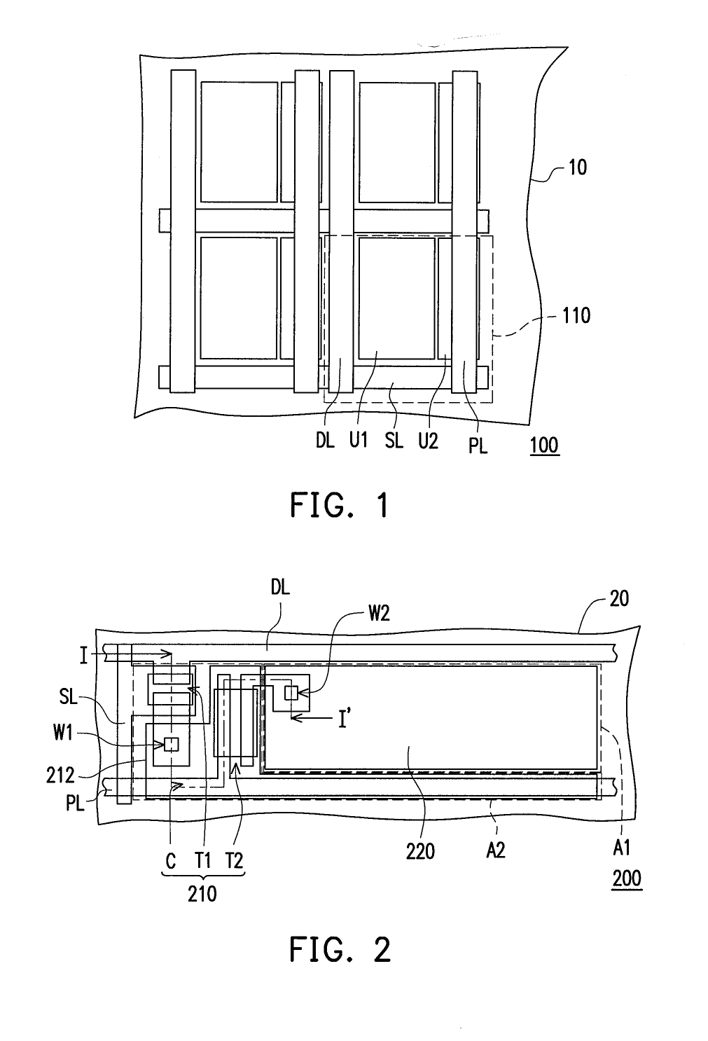

FIG. 1 is a schematic view illustrating an active light emitting device array according to a first embodiment of the invention. Referring to FIG. 1, an active light emitting device array 100 is disposed on a substrate 10 and includes a plurality of scan lines SL, a plurality of data lines DL, a plurality of power lines PL, a plurality of light emitting units U1, and a plurality of circuit units U2, wherein a segment of each scan line SL, a segment of each data line DL, and a segment of each power line PL are corresponding connected to one of the circuit units U2, and each circuit unit U2 is connected to one corresponding light emitting unit U1 to form an active light emitting unit 110. Therefore, the active light emitting device array 100 is substantially formed by a plurality of the active light emitting units 110 arranged in an array. In other words, each active light emitting device 110 includes a segment of one scan line SL, a segment of one data line DL, a segment of one power line PL, one circuit unit U2, and one light emitting unit U1.

The light emitting unit U1 can be an organic light emitting diode unit formed by organic light emitting materials. For driving the light emitting unit U1, the circuit unit U2 generally is formed by a plurality of transistors and at least one capacitor. It is understood that the larger the amount of the transistors and the capacitors, the greater the required area disposing the circuit unit U2, which restricts the light emitting area of the active light emitting device array 100, particularly when the light emitting unit U1 and the circuit unit U2 are not overlapped. Therefore, in the present embodiment, as shown in FIG. 1, the circuit unit U2 has at least a portion overlapped with the power line PL to reduce the disposing area of the circuit unit U2 so that the disposing area of the light emitting unit U1 is relatively enhanced within a the same predetermined layout area.

FIG. 2 is a schematic view illustrating an active light emitting device according to an embodiment of the invention. Referring to FIG. 2, an active light emitting device 200 disposed on a substrate 20 includes a scan line SL, a data line DL, a power line PL, a circuit unit 210 and a light emitting unit 220 for achieving the layout in which the circuit unit is overlapped with the light emitting unit. The circuit unit 210 is electrically connected to the scan line SL, the data line DL, and the power line PL. The light emitting unit 220 is driven by the circuit unit 210, wherein the light emitting unit 220 and the circuit unit 210 respectively define a light emitting region A1 and a circuit region A2 on the substrate 20.

Particularly, the circuit unit 210 includes a first thin film transistor T1, a second thin film transistor T2, and a storage capacitor C. The storage capacitor C is formed by an overlapping component 212 overlapped with the power line PL. The first transistor T1 is connected to the scan line SL, the data line DL, and the overlapping component 212, and the second transistor T2 is connected to the overlapping component 212, the power line PL, and the light emitting unit 220. It is noted that a portion of the power line PL forms a terminal of the storage capacitor C such that the power line PL and the storage capacitor C are overlapped with each other in the structure layout of the active light emitting device 200. Accordingly, the area of the light emitting area A1 in the present embodiment can be relatively increased and the area of the circuit region A2 is relatively decreased, which are conducive to enhance the light emitting brightness of the active light emitting device 200.

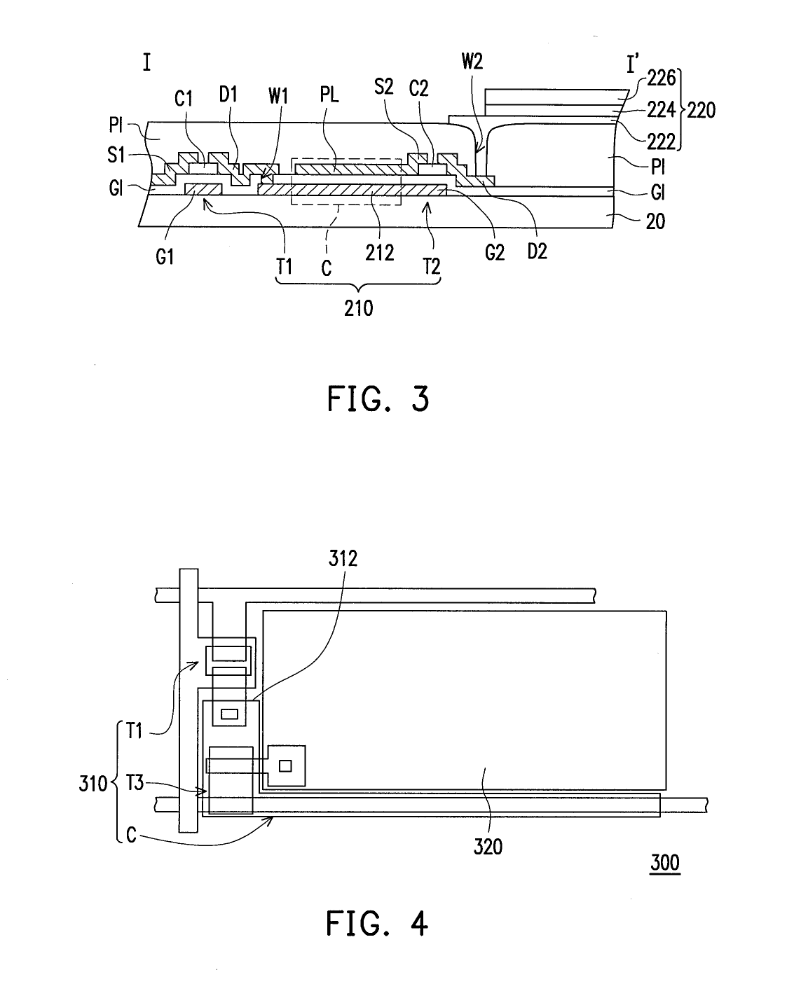

With respect to the present embodiment, a schematic cross-sectional view of the active light emitting device 200 taken along line I-I′ is shown in FIG. 3. Referring to FIG. 2 and FIG. 3 together, the first transistor T1 includes a gate G1, a channel layer C1, a source S1, and a drain D1. The second transistor T2 includes a gate G2, a channel layer C2, a source S2, and a drain D2. The storage capacitor C is formed by the power line PL and the overlapping component 212.

In the cross-section, the gate G1, the overlapping component 212 and the gate G2 are formed of the same layer such as a first metal layer. In addition, the scan line SL connected to the gate G1 is also formed by the first metal layer. The overlapping component 212 and the gate G2 are, for example, defined as the conductive patterns connected to each other so that the connection of the second transistor T2 and the storage capacitor C is accomplished. A gate insulation layer GI covers above the first metal layer and the gate insulation layer GI has a contact window W1 exposing the overlapping component 212. The channel layer C1 and the channel layer C2 are disposed on the gate insulation layer GI and respectively located over the gate G1 and the gate G2.

The source S1, the drain D1, the source S2, and the drain D2, similarly, are formed of the same layer such as a second metal layer. The data line DL connected to the source S1 and the power line PL connected to the source S2 are also formed by the second metal layer. The drain D1 can be connected to the overlapping component 212 of the storage capacitor C through the contact window W1, which achieves the connection of the first transistor T1 and the storage capacitor C. As shown in FIG. 3, the overlapping component 212 according to the present embodiment is located between the power line PL and the substrate 20. Nevertheless, the stacking sequence of the theses components can be modified with the change of the layer stacking (forming) sequence. Accordingly, the present embodiment merely serves as an exemplary description of the present invention and should not be construed as a limitation thereto. Certainly, the circuit unit 210 formed of two metal layers is merely exemplarily described as an example and the invention does not preclude the design of further using a third metal layer or using other conductive layers to construct the required components of the circuit unit 210.

A protection insulation layer PI covers above the second metal layer and the protection insulation layer PI has a contact window W2 exposing the drain D2. The light emitting unit 220 is disposed on the protection insulation layer PI and includes a first electrode 222, a light emitting layer 224, and a second electrode 226. The first electrode 222, the light emitting layer 224, and the second electrode 226 are sequentially stacked over the protection insulation layer PI while the first electrode 222 is connected to the drain D2 through the contact window W2. In the present embodiment, the light emitting layer 224 can be an organic light emitting layer and at least one film layer such as a carrier transporting layer, a carrier injection layer, a carrier blocking, or the like can be selectively disposed between the first electrode 22 and the light emitting layer 224 and between the light emitting layer 224 and the second electrode 226 for achieving the required device characteristic. The first electrode 222, for example, is a transparent electrode so that the light emitting device 200 can have a bottom emission design. Accordingly, the light emitting unit 220 is preferably configured beside the circuit unit 210 rather than overlapped with the circuit unit 210 for avoiding the light emitted by the light emitting unit 220 from being shielded by the circuit unit 210.

It is noted that the circuit unit 210 formed by two transistors and one storage capacitor is illustrated for descriptive purpose. In other embodiments, the amount configured in the circuit unit 210 can be more than two and the amount of the storage capacitor can be a plural. In addition, the configuration of the storage capacitor C overlapping with the power line PL is taken as an example in the present embodiment. In an alternate embodiment, the transistors configured in the circuit unit 210 can be selectively overlapped with the power line PL for further enhance the area of the light emitting area A1.

FIG. 4 is a schematic view illustrating an active light emitting device according to another embodiment of the invention. Referring to FIG. 4, an active light emitting device 300 is similar to the active light emitting device 200 in the foregoing embodiment and thus the like components in the two embodiments are denoted by the like reference numbers. The active light emitting device 300 includes a scan line SL, a data line DL, a power line PL, a circuit unit 310, and a light emitting unit 320. The circuit unit 310 is electrically connected to the scan line SL, the data line DL, and the power line PL. The light emitting unit 320 is driven by the circuit 310.

Particularly, the circuit unit 310 includes a first thin film transistor T1, a second thin film transistor T3, and a storage capacitor C. The storage capacitor C is formed by the overlapping component 312 overlapped with the power line PL. The first transistor T1 is connected to the scan line SL, the data line DL, and the overlapping component 312, and the second transistor T3 is connected to the overlapping component 312, the power line PL, and the light emitting unit 320. Herein, a portion of the power line PL forms a terminal of the second transistor T3 such that the second transistor T3 and the power line PL can be overlapped with each other to reduce the required disposing area of the circuit unit 310. Accordingly, the disposing area of the light emitting unit 320 can be increased relative to the disposing area of the light emitting unit 220 if the designs of the two embodiments are identical.

In summary, the circuit unit and the power are partially overlapped in the active light emitting device according to an embodiment of the present invention. Therefore, the disposing area of the light emitting unit can be increased for providing greater light emitting brightness. The display aperture can be improved when the active light emitting device of the embodiments of the invention is applied to the display.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An active light emitting device, disposed on a substrate, the active light emitting device comprising:
a scan line;
a data line;
a power line;
a circuit unit connected to the scan line, the data line, and the power line, the circuit unit at least comprising an overlapping component, wherein the overlapping component at least partially overlaps with the power line; and
a light emitting unit driven by the circuit unit, wherein the light emitting unit and the circuit unit respectively define a light emitting region and a circuit region on the substrate.

2. The active light emitting device as claimed in claim 1, wherein the light emitting unit comprises a first electrode, a light emitting layer, and a second electrode stacked sequentially and the first electrode is connected to the circuit unit.

3. The active light emitting device as claimed in claim 2, wherein the first electrode comprises a transparent electrode.

4. The active light emitting device as claimed in claim 2, wherein the light emitting layer comprises an organic light emitting layer.

5. The active light emitting device as claimed in claim 1, wherein the circuit unit further comprises a first transistor and a second transistor, the overlapping component and the power line together form a storage capacitor, the first transistor is connected to the scan line, the data line and the overlapping component, and the second transistor is connected to the overlapping component, the power line and the light emitting unit.

6. The active light emitting device as claimed in claim 1, wherein the overlapping component is disposed between the substrate and the power line.
